(19) United States
(12) Patent Application Publication
(10) Pub. No.: US 2014/0079411 A1
(43) Pub. Date: Mar. 20, 2014

(54) IMAGE FORMING SYSTEM

(71) Applicant: KONICA MINOLTA, INC., Tokyo (JP)

(72) Inventor: Yasushi SAITSU, Tokyo (JP)

(73) Assignee: KONICA MINOLTA, INC., Tokyo (JP)

(21) Appl. No.: 14/030,876

(22) Filed: Sep. 18, 2013

(30) Foreign Application Priority Data
Sep. 19, 2012 (JP) 2012-205319

(51) Int. Cl. G03G 15/00

(52) U.S. Cl. CPC G03G 15/70
USPC 399/21

(57) ABSTRACT

A user-friendly image forming system is described which can notify users of the situation of sheets remaining on conveying routes when a paper jam occurs. The image forming system includes a conveyance unit for conveying sheets, a display unit for displaying information, a jam determination unit for determining if a paper jam occurs on the conveying routes, and a control unit for controlling the conveyance unit and the display unit on the basis of the result of determination by the jam determination unit and the position of the sheet managed by a paper management unit. When a paper jam occurs, the control unit determines whether or not a sheet remaining on the conveying route can be automatically discharged by driving the conveyance unit, and displays the result of determination on the display unit in association with the position of the sheet.

### CROSS-REFERENCE TO RELATED APPLICATIONS

The present application claims priority under 35 U.S.C. §119 to Japanese Patent Application No. 2012-205319, filed Sep. 19, 2012. The contents of this application are herein incorporated by reference in their entirety.

### FIELD OF THE INVENTION

The present invention relates to an image forming system.

### DESCRIPTION OF THE RELATED ART

In recent years, image forming apparatuses are known which are capable of effectively performing various treatments for paper sheets. The apparatuses for performing such various treatments include, for example, of an image forming apparatus for performing image formation, a high-capacity paper feed unit capable of feeding a number of sheets for printing images to the image forming apparatus, a finisher for performing post-printing processes. An image forming system includes one or more such apparatuses which are connected in series in accordance with the specifications required of the system. When a paper jam occurs, the image forming system of this type halts the operation of each apparatus, and restarts the operation of the image forming system after removing the jammed sheet and other sheets (remaining sheets) which may be remaining in a conveying route.

For example, Japanese Patent Published Application No. 2011-145558 discloses an image forming apparatus which allows a user to shorten the recovery time that is taken to resume the operation of the image forming system after halting the operation due to paper jam. Specifically, the image forming system is provided with a remaining sheet detecting unit which detects a remaining sheet on a conveying route, and a determination unit which determines whether or not the remaining sheet is located in a position from which the remaining sheet can automatically be discharged by driving conveyance units. If it is determined that the remaining sheet can automatically be discharged, the determination unit next determines whether or not the user can manually remove the remaining sheet located in the position such that the image forming apparatus can resume the halted image formation operation earlier than when the remaining sheet is automatically discharged. The control unit of the image forming apparatus displays a message prompting a user to manually remove the remaining sheet when the downtime can be minimized by manual removal even if the remaining sheet can be automatically discharged.

However, according to the technique disclosed in Japanese Patent Published Application No. 2011-145558, while it is determined whether to automatically discharge or manually remove the sheet remaining on a conveying route, the user is not informed of the result of determination and the situation of the remaining sheet. Because of this, the remaining sheet might not be handled in such a manner as the user desires.

The present invention has been made in order to solve the problems as described above. It is an object of the present invention therefore to provide a user-friendly image forming system which notifies users of the situation of sheets remaining on conveying routes when a paper jam occurs.

### SUMMARY OF THE INVENTION

To achieve at least one of the abovementioned objects, an image forming system reflecting one aspect of the present invention performs a predetermined process of a sheet conveyed along a conveying route, and comprises: a conveyance unit configured to convey the sheet; a display unit configured to display information; a jam determination unit configured to determine if a paper jam occurs on the conveying route; a paper management unit configured to manage the position of the sheet along the conveying route; and a control unit configured to control the conveyance unit and the display unit on the basis of the result of determination by the jam determination unit and the position of the sheet managed by the paper management unit. Particularly, when a paper jam occurs, the control unit determines whether or not a sheet remaining on the conveying route can be automatically discharged by driving the conveyance unit, and displays the result of determination on the display unit in association with the position of the sheet.

In a preferred embodiment, the image forming system comprises a plurality of apparatuses connected in series. In this case, the control unit determines whether or not a sheet can automatically be discharged on the basis of the type of an apparatus in which the sheet is remaining, the position of the sheet in the apparatus and/or the condition of the apparatus in which the sheet is remaining.

Also, in a preferred embodiment, when it is determined that a sheet is located in a position extending over a plurality of the conveyance units having different responsive behaviors to the operation of stopping conveyance of the sheet, the control unit determines that the sheet cannot automatically be discharged.

Furthermore, in a preferred embodiment, when a sheet is remaining in a location where the conveying route curves with a curvature no lower than a threshold value, the control unit determines that the sheet cannot automatically be discharged.

Furthermore, in a preferred embodiment, when it is determined that a sheet is remaining in an image forming apparatus, the control unit determines that the sheet cannot automatically be discharged.

Furthermore, in a preferred embodiment, when a sheet is jammed in an apparatus in which another sheet remains in the conveying route, the control unit determines that the sheet cannot automatically be discharged.

Furthermore, in a preferred embodiment, when it is determined that a sheet is remaining in an image forming apparatus with a housing door being opened, the control unit determines that the sheet cannot automatically be discharged.

Furthermore, in a preferred embodiment, the image forming system comprises a plurality of apparatuses connected in series. In this case, when it is determined that a sheet is located in a position extending over a plurality of the apparatuses, the control unit determines that the sheet cannot automatically be discharged.

Furthermore, in a preferred embodiment, the control unit displays, on the manipulation display, a jammed sheet and a sheet which is remaining on the conveying route and determined as a sheet to be manually removed on the display unit.

In this case, when it is determined that the jammed sheet and the sheet determined as a sheet which cannot be automatically discharged have been removed from the conveying routes, the control unit preferably displays a sheet determined as a sheet which can be automatically discharged on the display unit as a sheet to be automatically discharged.

Furthermore, in a preferred embodiment, when the housing door of an apparatus is opened in advance of automatically discharging the sheets, the control unit displays a sheet remaining in the apparatus with the opened housing door as a sheet to be manually removed on the display unit.

### BRIEF DESCRIPTION OF THE DRAWINGS

FIG. 1 is an explanatory view for schematically showing the structure of an image forming system in accordance with an embodiment of the present invention.

FIG. 2 is a block diagram for showing the control architecture of the image forming system.

FIG. 3 is a block diagram for showing the functions implemented by a CPU of an image forming apparatus of the image forming system.

FIG. 4 is an explanatory view for showing an example of a message displayed on a manipulation display of the image forming system.

FIG. 5 is a flow chart for showing the steps of controlling the image forming system when a paper jam occurs.

FIG. 6 is an explanatory view for showing an example of a message displayed on the manipulation display.

FIG. 7 is a flow chart for showing the details of a remaining sheet check process in accordance with the embodiment of the present invention.

FIG. 8 is an explanatory view for showing another example of a message displayed on the manipulation display.

FIG. 9 is an explanatory view for showing a further example of a message displayed on the manipulation display.

FIG. 10 is an explanatory view for showing a still further example of a message displayed on the manipulation display.

FIG. 11 is an explanatory view for showing a still further example of a message displayed on the manipulation display.

FIG. 12 is an explanatory view for showing a still further example of a message displayed on the manipulation display.

FIG. 13 is an explanatory view for showing a still further example of a message displayed on the manipulation display.

FIG. 14 is an explanatory view for showing a still further example of a message displayed on the manipulation display.

### DETAILED DESCRIPTION OF THE PREFERRED EMBODIMENT

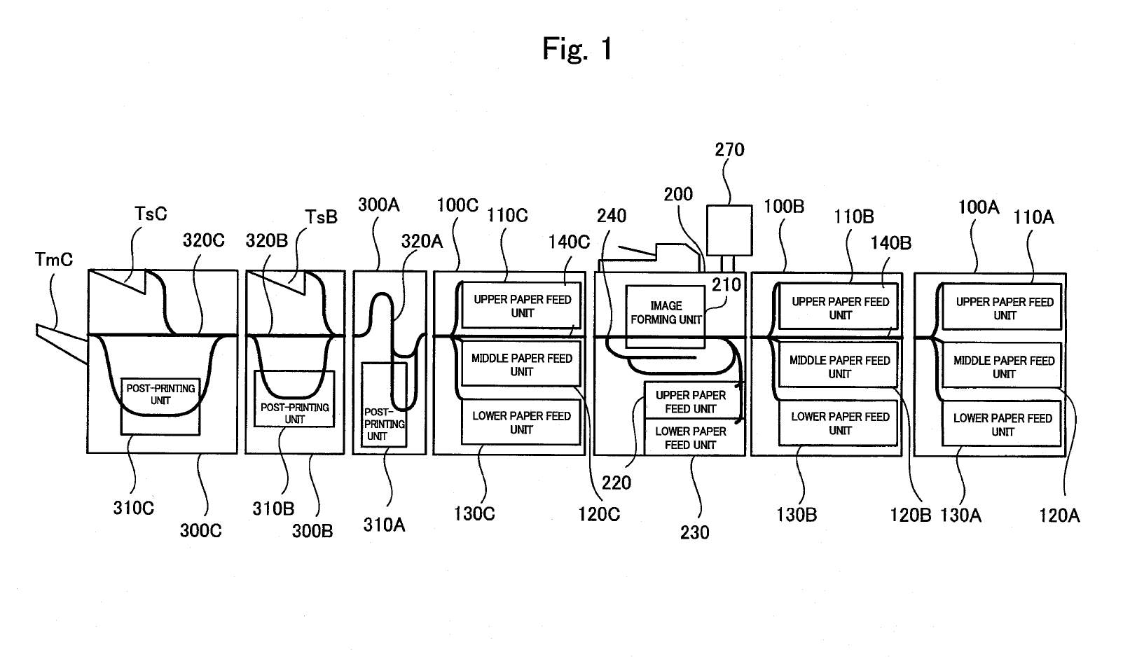

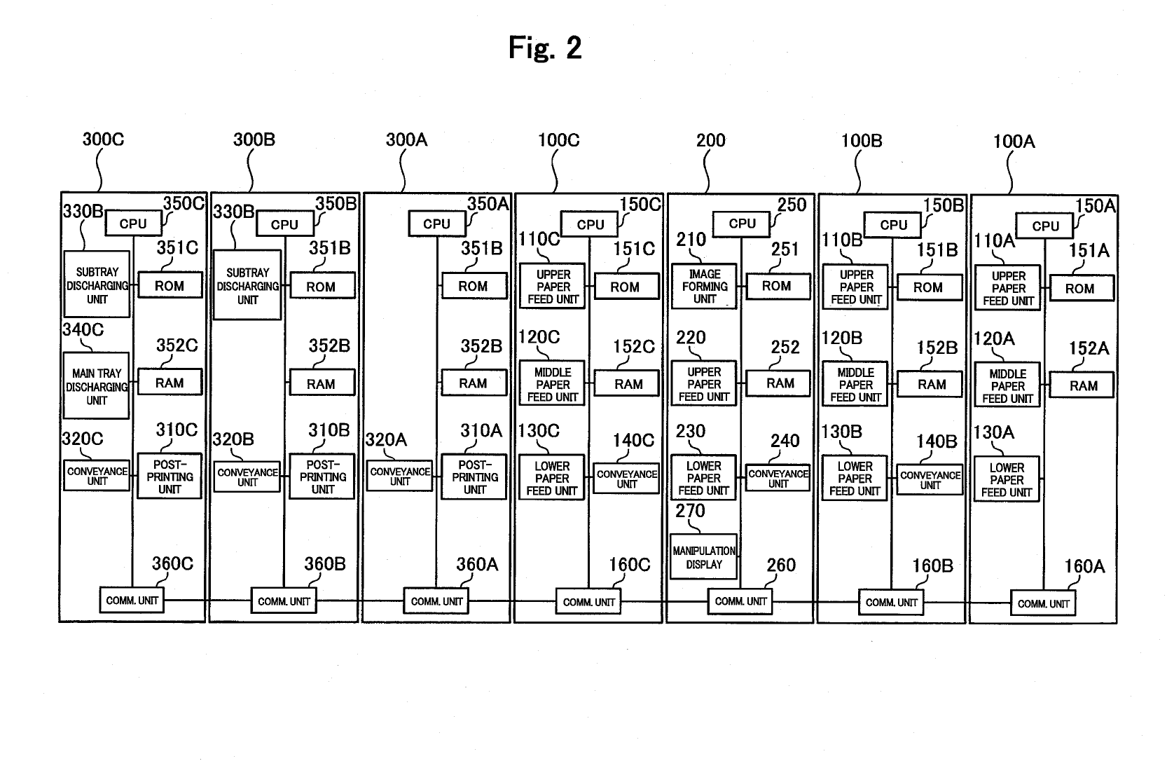

FIG. 1 is an explanatory view for schematically showing the structure of an image forming system in accordance with an embodiment of the present invention. FIG. 2 is a block diagram for showing the control architecture of this image forming system. The image forming system is, for example, a system which forms images and performs post-printing processes, and consists of a plurality of apparatuses connected in series. The image forming system of this embodiment includes three large volume paper feed apparatuses 100A, 100B and 100C, an image forming apparatus 200, and three finishers 300A, 300B and 300C. These apparatuses are arranged in the order as the first large volume paper feed apparatus 100A, the second large volume paper feed apparatus 100B, the image forming apparatus 200, the third large volume paper feed apparatus 100C, the first finisher 300A, the second finisher 300B and the third finisher 300C from the upstream side to the downstream side in the sheet conveying direction.

The first large volume paper feed apparatus 100A is an apparatus for accumulating and storing a large amount of sheets and feeding the sheets to the image forming apparatus 200. This first large volume paper feed apparatus 100A consists mainly of an upper paper feed unit 110A, a middle paper feed unit 120A, an lower paper feed unit 130A and a CPU 150A as shown in FIG. 2.

The upper paper feed unit 110A is provided with a paper feed tray located in an upper position, and a conveyance mechanism consisting of a plurality of conveyance rollers, a drive motor and a guide member. The sheets stored in the upper paper feed unit 110A is extracted one by one from the paper feed tray and conveyed through a conveying route. Likewise, the middle paper feed unit 120A is provided with a paper feed tray located in a middle position, and a conveyance mechanism consisting of a plurality of conveyance rollers, a drive motor and a guide member, and the sheets is extracted one by one from the paper feed tray and conveyed through a conveying route. Furthermore, the lower paper feed unit 130A is provided with a paper feed tray located in a lower position, and a conveyance mechanism consisting of a plurality of conveyance rollers, a drive motor and a guide member, and the sheets is extracted one by one from the paper feed tray and conveyed through a conveying route. A sheet conveyed from each of the paper feed units 110A to 130A is discharged outwards from the first large volume paper feed apparatus 100A, and supplied to the second large volume paper feed apparatus 100B.

The CPU 150A controls the first large volume paper feed apparatus 100A. The CPU 150A loads a control program stored in the ROM 151A, and executes the control program on the RAM 152B in order to integrally control the units of the first large volume paper feed apparatus 100A. The first large volume paper feed apparatus 100A also includes a communication unit 160A which is an interface for establishing connection with constituent elements of the image forming system and, performing data transmission and reception from/to the CPU 150A.

The second large volume paper feed apparatus 100B is an apparatus for accumulating and storing a large amount of sheets and feeding the sheets to the image forming apparatus 200. This second large volume paper feed apparatus 100B consists mainly of an upper paper feed unit 110B, a middle paper feed unit 120B, an lower paper feed unit 130B and a CPU 150B. The paper feed units 110B through 130B and the CPU 150B have similar structures as those of the first large volume paper feed apparatus 100A respectively, and therefore no redundant description is repeated.

The second large volume paper feed apparatus 100B is provided further with a conveyance unit 140B which transfers a sheet from the first large volume paper feed apparatus 100A to the image forming apparatus 200 connected in the downstream side. The conveyance unit 140B is provided with a conveyance mechanism consisting of a plurality of conveyance rollers, a drive motor and a guide member, receives a sheet from the first large volume paper feed apparatus 100A, and conveys the sheet along a predetermined conveying route. A sheet conveyed by the conveyance unit 140B or any one of the paper feed units 110B to 130B is discharged outwards from the second large volume paper feed apparatus 100B, and supplied to the image forming apparatus 200.

The image forming apparatus 200 is, for example, an electrophotographic image forming apparatus which forms images on sheets. The image forming apparatus 200 consists mainly of an image forming unit 210, an upper paper feed unit 220, a lower paper feed unit 230, a conveyance unit 240, a CPU 250 and a manipulation display 270.

This image forming apparatus 200 is provided with an original reading unit and an automatic document feeder (not shown in the figure) installed on the top of the image forming apparatus 200 so that, while successively feeding originals, image signals can be captured by scanning the image of each original with the original reading unit. The image signals are output to the image reading control unit. The image reading control unit processes the image signals by performing A/D conversion, shading compensation, data compression and so on to obtain image data, and outputs the image data to the CPU 250. Incidentally, the image data input to the CPU 250 is not limited to the image data as captured by the original reading unit, but can be the data for example as received from another image forming apparatus, a personal computer (PC) or the like connected to the image forming apparatus.

The image forming unit 210 serves to form images on sheets. The image forming unit 210 of this embodiment is capable of electrophotographically forming an image on a sheet, and consists, for example, of photoreceptor drums and exposure units each of which including a laser source and an optical system, together with a charging/developing unit, a transfer unit and a fixing unit which are arranged around each photoreceptor drum. This image forming unit 210 forms an image on a sheet in accordance with image data by a series of steps of (1) charging the photoreceptor drums, (2) forming electrostatic latent images on the photoreceptor drums with the exposure units, (3) making toner adhere to the electrostatic latent images as formed, (4) transferring the electrostatic latent images (toner images) to the sheet, and (5) fixing the toner images to the sheet.

The upper paper feed unit 220 is provided with a paper feed tray located in an upper position, and a conveyance mechanism consisting of a plurality of conveyance rollers, a drive motor and a guide member. The sheets stored in the upper paper feed unit 220 is extracted one by one from the paper feed tray and conveyed to the conveyance unit 240. Also, the lower paper feed unit 230 is provided with a paper feed tray located in a lower position, and a conveyance mechanism consisting of a plurality of conveyance rollers, a drive motor and a guide member. The sheets stored in the upper paper feed unit 230 is extracted one by one from the paper feed tray and conveyed to the conveyance unit 240.

The conveyance unit 240 serves to convey sheets, and provided with a plurality of conveyance rollers, a drive motor and a guide member and so forth. When receiving a sheet supplied from the upper paper feed unit 220 or the lower paper feed unit 230, or from the first large volume paper feed apparatus 100A or the second large volume paper feed apparatus 100B located in the upstream side, this conveyance unit 240 conveys the sheet along the conveying route to supply the sheet to the image forming unit 210 where the sheet is subjected to several processes.

After completing image formation, the sheet is discharged outwards by the conveyance unit 240 and supplied to the third large volume paper feed apparatus 100C connected in the downstream side. Incidentally, when images are formed on both sides of a sheet, the conveyance unit 240 switches the direction of conveying the sheet to which an image is fixed, to the direction toward a sheet reversing conveyance unit (downwards in the figure). The sheet reversing conveyance unit reverses the front and back sides of the sheet, and conveys the sheet to the image forming unit 210 again.

The CPU 250 controls the image forming apparatus 200. The CPU 250 loads a control program stored in the ROM 251, and executes the control program on the RAM 252 in order to integrally control the units of the image forming apparatus 200. The image forming apparatus 200 also includes a communication unit 260 which is an interface for establishing connection with constituent elements of the image forming system and, performing data transmission and reception from/to the CPU 250.

Furthermore, one of the characteristic features of the present embodiment is that the CPU 250 integrally controls the constituent units of the image forming apparatus 200 respectively. The operation of this CPU 250 makes it possible to perform the operations of the constituent units in operative association with each other. Meanwhile, the overall control scheme of the image forming system to be performed by the CPU 250 will be described below in detail.

The manipulation display 270 is a device which can receive input and display information, for example, a touch panel system through which a user can enter data in accordance with information displayed on a display. Through the manipulation display 270, the CPU 250 can acquire printing information, which is set up by a user, i.e., the printing conditions of a job (for example, the mode of single/double-side printing, the number of print copies, the types of the post-printing processes to be performed, the density and reduce/enlarge ratio of images, and so forth), and a command of starting the print job.

The third large volume paper feed apparatus 100C is an apparatus for accumulating and storing a large amount of sheets and feeding the sheets to either one of the finishers 300A, 300B and 300C. This third large volume paper feed apparatus 100C consists mainly of an upper paper feed unit 110C, a middle paper feed unit 120C, an lower paper feed unit 130C and a CPU 150C. The structures of these constituent elements are the same as those of the first large volume paper feed apparatus 100A, and therefore no redundant description is repeated.

Furthermore, the third large volume paper feed apparatus 100C is provided with a conveyance unit 140C which transfers a sheet supplied from the image forming apparatus 200 to the first finisher 300A connected in the downstream side. The conveyance unit 140C is provided with a conveyance mechanism consisting of a plurality of conveyance rollers, a drive motor and a guide member, receives a sheet from the image forming apparatus 200, and conveys the sheet along a predetermined conveying route. A sheet conveyed by the conveyance unit 140C or any one of the paper feed units 110C to 130C is discharged outwards from the second large volume paper feed apparatus 100C, and supplied to the first finisher 300A.

The first finisher 300A is a device which performs a post-printing process for a sheet supplied from the third large volume paper feed apparatus 100C. This first finisher 300A consists mainly of a post-printing unit 310A, a conveyance units 320A and a CPU 350A.

The post-printing unit 310A serves to perform the post-printing process. The post-printing process is for example a folding process of folding a sheet in various ways, a punching process of punching a sheets, a bookbinding process of folding, saddle-stitching and trimming a plurality of sheets, a staple process of stapling a plurality of printed sheets together, or the like. The post-printing unit 310A can perform a predetermined post-printing process for sheets by itself or in cooperation with the second finisher 300B and/or the third finisher 300C to be described below.

The conveyance unit 320A serves to convey sheets, and includes a plurality of conveyance rollers, a drive motor and a guide member. When receiving a sheet supplied from the third large volume paper feed apparatus 100C, this conveyance unit 320A conveys the sheet along the conveying route to supply the sheet to the post-printing unit 310A for performing a post-printing process. The conveyance unit 320A then discharges the sheet which has been subjected to the post-printing process by the post-printing unit 310, and supplies the second finisher 300B with the sheet.

The CPU 350A controls the first finisher 300A. The CPU 350A loads a control program stored in the ROM 351A, and executes the control program on the RAM 352B in order to integrally control the units of the first finisher 300A. The first finisher 300A also includes a communication unit 360A which is an interface for establishing connection with constituent elements of the image forming system and, performing data transmission and reception from/to the CPU 350A.

Incidentally, this first finisher 300A can discharge a sheet supplied from the third large volume paper feed apparatus 100C outwards without processing this sheet.

The second finisher 300B is a device which performs a post-printing process for a sheet supplied from the first finisher 300A. This second finisher 300B consists mainly of a post-printing unit 310B, a conveyance unit 320B and a CPU 350B. The structures of these constituent elements are the same as those of the first finisher 300A, and therefore no redundant description is repeated.

The second finisher 300B is provided further with a subtray discharging unit 330B for discharging a sheet supplied from the first finisher 300A to a subtray TsB which is located in an upper position of the second finisher 300B.

The third finisher 300C is a device which performs a post-printing process for a sheet supplied from the second finisher 300B. This third finisher 300C consists mainly of a post-printing unit 310C, a conveyance units 320C and a CPU 350C. The structures of these constituent elements are the same as those of the first finisher 300A, and therefore no redundant description is repeated.

Also, the third finisher 300C is provided further with a subtray discharging unit 330C for discharging a sheet supplied from the second finisher 300B to a subtray TsC which is located in an upper position of the second finisher 300C, and a main tray discharging unit 340C for discharging a sheet supplied from the second finisher 300B to a main tray TmC which is located in a side position of the third finisher 300C.

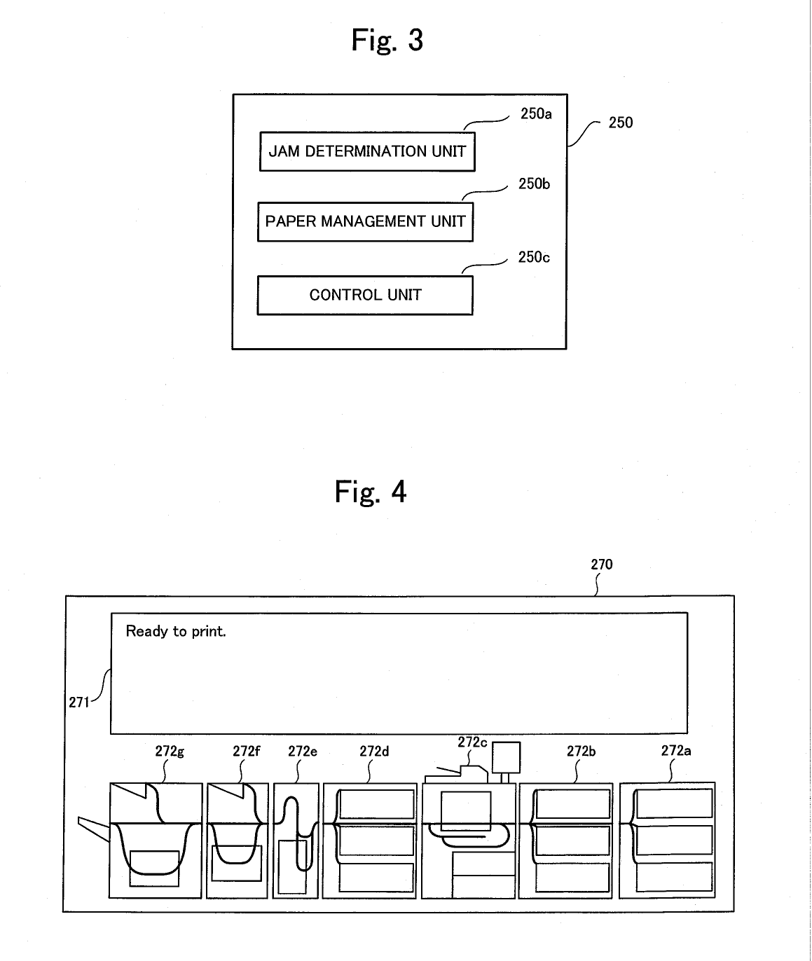

In this image forming system as described above, the CPU 250 of the image forming apparatus 200 integrally controls the apparatuses. As shown in FIG. 3, the CPU 250 functions as a jam determination unit 250a, a paper management unit 250b and a control unit 250c which are implemented by the program.

The jam determination unit 250a determines that a paper jam occurs in the conveying routes of the image forming system (a combination of the conveying routes of the apparatuses). For example, the jam determination unit 250a makes use of the detection result output from a sensor unit (not shown in the figure) to determine that a paper jam occurs. In this case, the sensor unit includes a plurality of sensors (e.g. photoreflectors) for detecting a sheet on a conveying route and where the sheet is located. These sensors are discretely arranged on the conveying route of each apparatus. The jam determination unit 250a can acquire the detection results of the sensors by communicating with each apparatus to determine if a paper jam occurs in any apparatus and where the jammed sheet is located.

The paper management unit 250b manages the conveying position of a sheet on the conveying routes. Specifically, the paper management unit 250b successively manages the conveying position of each of sheets conveyed on the conveying routes on the basis of the detection results output from the sensor unit and the timing of supplying a sheet.

The control unit 250c controls the manipulation display 270 and the conveyance unit of each apparatus on the basis of the result of determination output from the jam determination unit 250a and the position of each sheet managed by the paper management unit 250b. In particular, when a paper jam occurs, the control unit 250c outputs a halt command to each apparatus to halt the operation of each apparatus and stop the conveyance of sheet(s). The control unit 250c then determines whether or not the sheet which is remaining on a conveying route (hereinafter referred to as “remaining sheet”) can automatically be discharged, and displays the result of determination on the manipulation display 270 in association with the position of the remaining sheet. Incidentally, it is meant here by “automatic discharge” that a remaining sheet is discharged to a predetermined catch tray (subtray TsB or TsC) by driving the conveyance unit of each apparatus.

Furthermore, the control unit 250c controls the manipulation display 270 to display a variety of information on the manipulation display 270. For example, as shown in FIG. 4, the control unit 250c can display a message to be notified to a user on an information notification area 271 together with symbols 272a to 272g representing the apparatuses and including the conveying routes and so forth.

The housing of each apparatus is provided with a door which can be opened for performing maintenance and manually removing a remaining sheet. The control unit 250c can know if the door is opened or closed through a sensor (not shown in the figure). Specifically, the control unit 250c is notified through communication with the other apparatuses that the door of any apparatus is opened or closed.

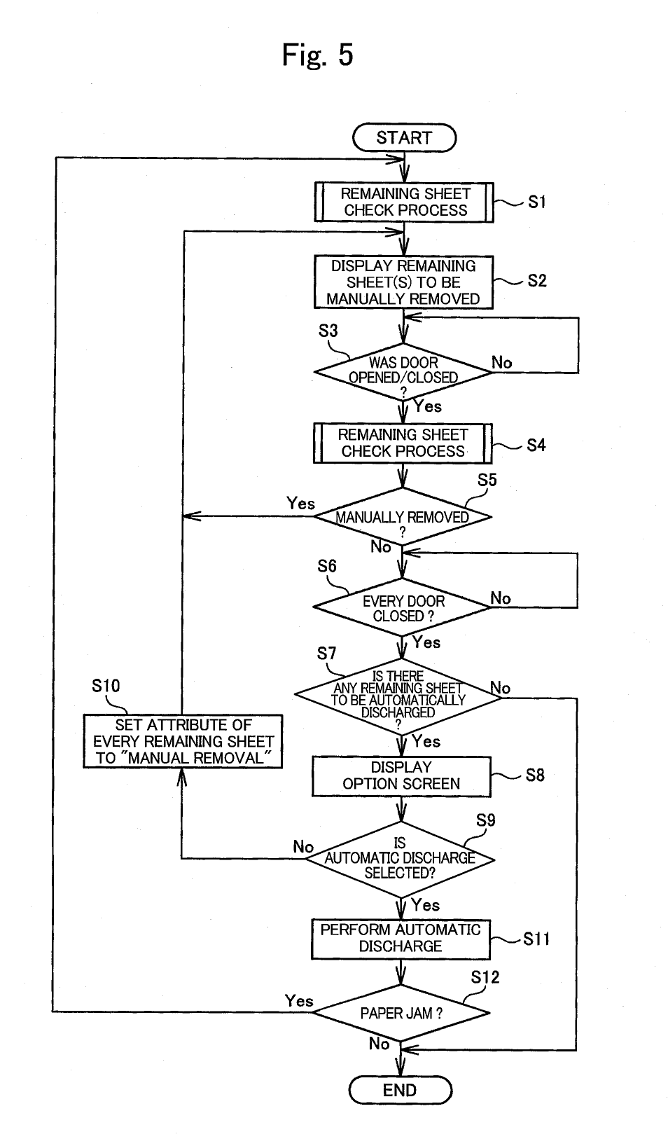

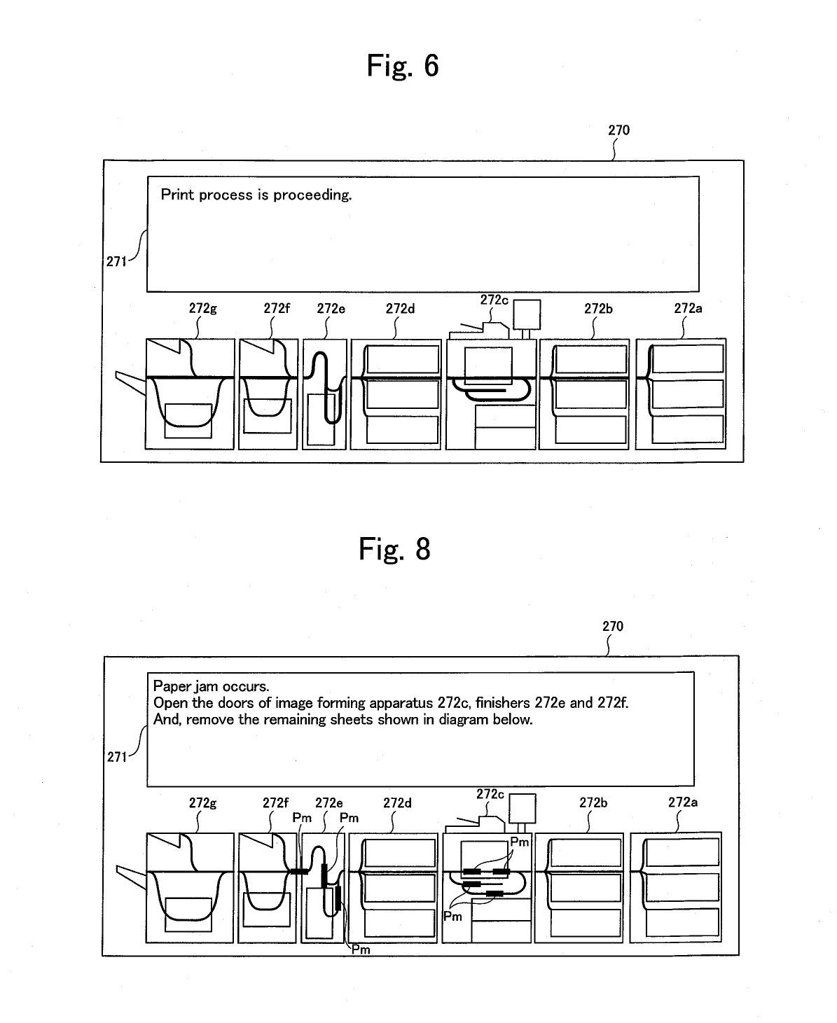

FIG. 5 is a flow chart for showing the steps of controlling the image forming system when a paper jam occurs. The process shown in the same figure is called when the jam determination unit 250a determines that a paper jam occurs and executed by the control unit 250c. In this case, as shown in FIG. 6, until it is determined that a paper jam occurs, the control unit 250c displays, on the information notification area 271, a message notifying that a print process is proceeding and the symbols 272a to 272g corresponding to the apparatuses respectively in which the conveying routes thereof are indicated. Also, when a paper jam occurs, the control unit 250c outputs a halt command to each apparatus to halt the operation of each apparatus and stop the conveyance of sheet(s).

First, in step 1 (S1), the control unit 250c performs a remaining sheet check process. The remaining sheet check process is a process of determining whether or not there is a remaining sheet.

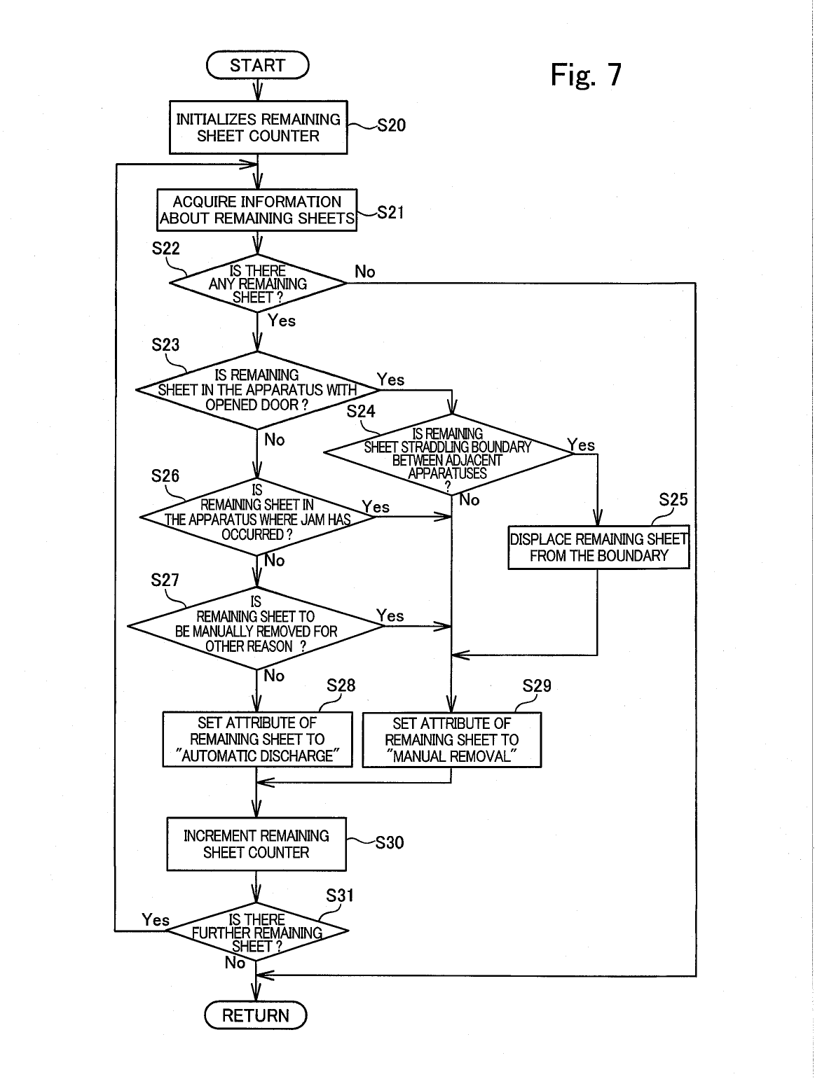

FIG. 7 is a flow chart for showing the details of the remaining sheet check process. In step 20 (S20), the control unit 250c initializes a remaining sheet counter. In step 23 (S23) and the subsequent steps, the control unit 250c determines, for each of the sheets remaining on the conveying routes, whether or not the automatic discharge is viable. The remaining sheet counter designates a remaining sheet to be checked. After the initialization, the first remaining sheet is designated.

In step 21 (S21), the control unit 250c acquires the information about remaining sheets from the paper management unit 250b.

In step 22 (S22), the control unit 250c determines whether or not there is a remaining sheet. If the determination is in the affirmative in step 22, i.e., if there is a remaining sheet, the process proceeds to step 23. Conversely, if the determination is in the negative in step 22, i.e., if there is no remaining sheet, this routine returns.

Next, the control unit 250c performs step 23 and the subsequent steps to determine whether or not the sheet corresponding to the current count of the remaining sheet counter can automatically be discharged. For example, the control unit 250c given an arbitrary identification number to each remaining sheet on the conveying routes with reference to the information from the paper management unit 250b, and determines whether or not each remaining sheet on the conveying routes can automatically be discharged by performing step 23 and the subsequent steps with reference to the count of the remaining sheet counter.

First, in step 23, the control unit 250c determines whether or not a remaining sheet is remaining in an apparatus whose housing door has been opened/closed after a paper jam occurred. If the housing door of the apparatus is opened/closed after jamming, a user may have touched or moved the remaining sheet in the apparatus. In this case, even if a conveyance unit is driven to automatically discharge the remaining sheet, it may fail to appropriately convey the remaining sheet for discharging so that such a sheet which might be moved by a user is excluded from those to be automatically discharged. The determination in step 23 is provided for this reason. If the determination is in the affirmative in step 23, the process proceeds to step 24 (S24). Conversely, the determination is in the negative in step 23, the process proceeds to step 26 (S26).

Incidentally, in step 23, it is determined if a housing door is opened/closed after jamming, in order to determine if a user accesses a remaining sheet in the housing. The means for determining the access to a remaining sheet is not limited thereto. For example, in step 23, unlocking a housing door or drawing out a unit from a housing can be detected for the same purpose.

In step 24, the control unit 250c determines whether or not a remaining sheet is located in a position extending over a plurality of the apparatuses. Different apparatuses can have different characteristics and configurations. When a remaining sheet stops in a position extending over a plurality of the apparatuses, the remaining sheet may be buckled and folded due to the differential behavior between the adjacent apparatuses during stopping the remaining sheet. In this case, even if a conveyance unit is driven to automatically discharge the remaining sheet, it may fail to appropriately convey the remaining sheet for discharging so that such a sheet which might be moved by a user is excluded from those to be automatically discharged. The determination in step 24 is provided for this reason. If the determination is in the affirmative in step 24, the process proceeds to step 25 (S25). Conversely, the determination is in the negative in step 24, the process proceeds to step 29 (S29).

In step 25, the control unit 250c outputs a command to the apparatuses between which the remaining sheet is located to convey the remaining sheet such that the remaining sheet is moved to the inside of either apparatus. While a remaining sheet can be manually removed from an apparatus by opening a door of the apparatus housing and drawing out a unit from the apparatus housing, if a remaining sheet is straddling the boundary between adjacent apparatuses, the remaining sheet may interfere with the frame of the apparatus to hinder the unit from being drawn out, and may tear when the unit is forcibly drawn out. The remaining sheet is thereby retracted into one of the adjacent apparatuses in order to avoid such a situation.

In step 26, the control unit 250c determines whether or not the remaining sheet is located in the apparatus where the paper jam has occurred. The jammed sheet has to be manually removed by the user. When a door of an apparatus housing is opened by a user for the purpose of removing a jammed sheet, there may be another remaining sheet in the same apparatus. In such a case, this another remaining sheet may be found by the user who then may touch and move this remaining sheet besides the jammed sheet to be manually removed. In this case, even if driving a conveyance unit, the remaining sheet can possibly not appropriately be conveyed and removed automatically. The remaining sheet located in the apparatus where a paper jam has occurred is excluded from those to be automatically discharged. The determination in step 24 is provided for this reason. If the determination is in the affirmative in step 26, the process proceeds to step 29. Conversely, the determination is in the negative in step 26, the process proceeds to step 27 (S27).

In step 27, the control unit 250c determines whether or not the remaining sheet is to be removed for any reason other than in steps 23, 24 and 26. For example, (1) if the remaining sheet is stopping in a location where a conveying route curves with a large curvature, the remaining sheet may be irreversibly curved corresponding to the curvature. (2) If the remaining sheet is stopping in a position extending over a plurality of the conveyance units which are located in the same apparatus but have different responsive behaviors to the stopping operation, the remaining sheet may be buckled and folded due to the differential behavior between the adjacent conveyance units during stopping the remaining sheet. (3) The above situations (1) and (2) can be true in the image forming apparatus 200. In the above situations (1), (2) and (3), even if a conveyance unit is driven to automatically discharge the remaining sheet, it may fail to appropriately convey the remaining sheet for discharging so that such a sheet corresponding to one of the situations is excluded from those to be automatically discharged. If the determination is in the affirmative in step 27, the process proceeds to step 29. Conversely, the determination is in the negative in step 27, the process proceeds to step 28 (S28).

In step 28, the control unit 250c sets an attribute of the remaining sheet to “automatic discharge”. On the other hand, in step 29, the control unit 250c sets the attribute of the remaining sheet to “manual removal”.

In step 30 (S30), the control unit 250c increments the remaining sheet counter.

In step 31 (S31), the control unit 250c determines whether or not there is a subsequent remaining sheet. If the determination is in the affirmative in step 31, the process is returned to step 21. Conversely, if the determination is in the negative in step 31, this routine returns control.

Referring to FIG. 5 again, in step 2 (S2), the control unit 250c displays, on the manipulation display 270, the jammed sheet Pm and the remaining sheet(s) Pm whose attribute is set to “manual removal” in association with the positions of these remaining sheets respectively in the conveying routes. The control unit 250c further displays a message notifying that these remaining sheets are to be manually removed on the manipulation display 270. FIG. 8 is an explanatory view for showing an example of such a message displayed on the manipulation display 270. By displaying the remaining sheet(s) Pm which cannot be automatically discharged in association with the positions thereof respectively as shown in the same figure, it is possible to notify the user of every remaining sheet Pm to be manually removed including the jammed sheet.

In step 3 (S3), the control unit 250c determines whether or not the housing door of an apparatus is opened/closed after jamming. By this determination, it is estimated whether or not the user has taken any action to remove the jammed sheet and the remaining sheet to be manually removed if any. If the determination is in the affirmative in step 3, the process proceeds to step 4 (S4). Conversely, the determination is in the negative in step 3, the control unit 250c performs determination again in step 3.

In step 4, the control unit 250c performs the remaining sheet check process. This remaining sheet check process is the same as explained in step 1.

In step 5 (S5), the control unit 250c determines whether or not there is a remaining sheet whose attribute is set to “manual removal” in a conveying route. If the determination is in the affirmative in step 5, the process proceeds to step S2 again. Conversely, if the determination is in the negative in step 5, the process proceeds to step 6 (S6).

In step 6, the control unit 250c determines whether or not every housing door of all the apparatuses in the image forming system has been closed. If the determination is in the affirmative in step 6, the process proceeds to step 7 (S7) again. Conversely, if the determination is in the negative in step 6, the control unit 250c performs determination again in step 6.

In step 7, the control unit 250c determines whether or not there is a remaining sheet whose attribute is set to “automatic discharge” in a conveying route. If the determination is in the affirmative in step 7, the process proceeds to step 8 (S8). Conversely, if the determination is in the negative in step 7, this routine returns.

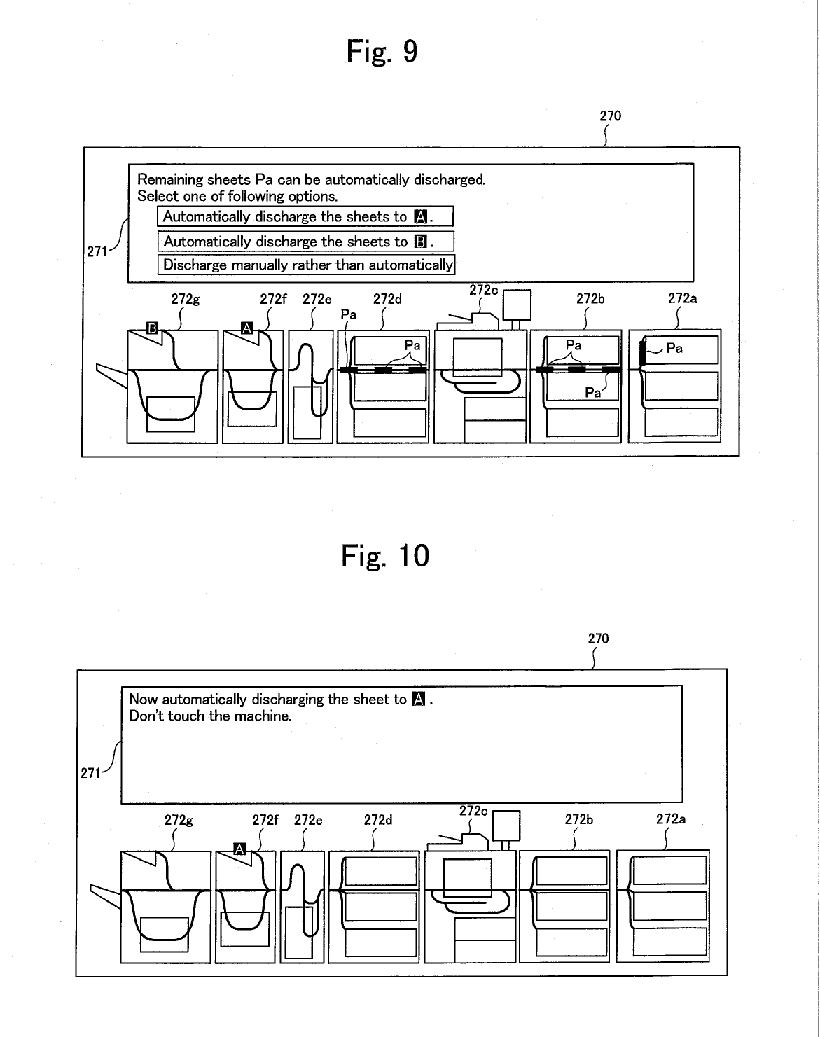

In step 8, the control unit 250c displays, on the manipulation display 270, the remaining sheet(s) Pa whose attribute is set to “automatic discharge” in association with the positions thereof respectively in the conveying routes. The control unit 250c also displays, on the manipulation display 270, a message prompting the user to select the automatic discharge or the manual removal of the remaining sheet(s) which can be automatically discharged. FIG. 9 is an explanatory view for showing an example of such a message displayed on the manipulation display 270. Furthermore, the control unit 250c displays, on the manipulation display 270, options for selecting the destination of the automatic discharge.

In step 9 (S9), the control unit 250c determines whether or not the automatic discharge is selected through manipulation by the user responsive to the message displayed in step 8. If the determination is in the negative in step 9, the process proceeds to step 10 (S10). Conversely, if the determination is in the affirmative in step 9, the process proceeds to step 11 (S11).

In step 10, the control unit 250c sets the attribute of every remaining sheet to “manual removal”.

In step 11, the control unit 250c controls the conveyance units of the apparatuses to perform the automatic discharge. If the user has designated a subtray as the destination of the automatic discharge, the control unit 250c discharges the remaining sheet(s) to the designated subtray. Also, as shown in FIG. 10, the control unit 250c may displays, on the manipulation display 270, a message notifying that the remaining sheet(s) is being automatically discharged.

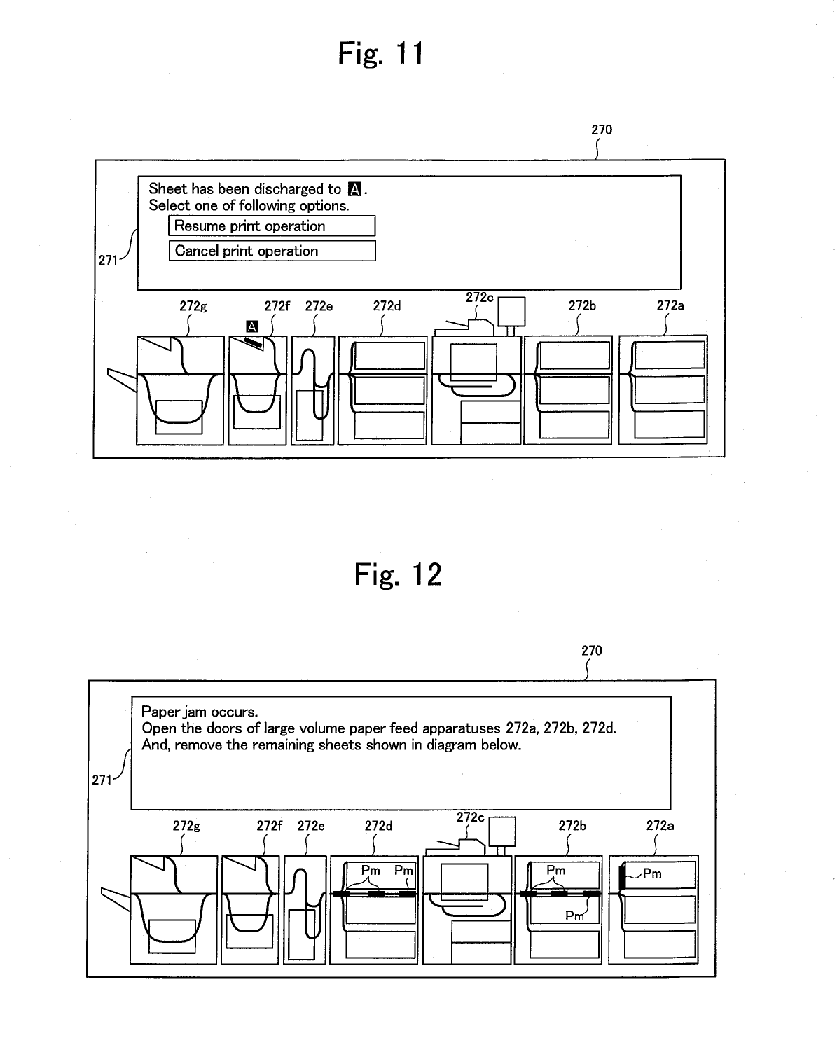

In step 12 (S12), the control unit 250c determines whether or not a paper jam occurs during the automatic discharge. If the determination is in the negative in step 12, this routine returns. In this case, as shown in FIG. 11, the control unit 250c displays, on the manipulation display 270, a message notifying that the automatic discharge is completed. On the other hand, if the determination is in the affirmative in step 12, the process is returned to step 1. In this case, after steps 1 and 2, the control unit 250c displays, on the manipulation display 270, the jammed sheet Pm and the remaining sheet(s) Pm whose attribute is set to “manual removal” in association with the positions of these remaining sheets respectively in the conveying routes as illustrated in FIG. 12.

In accordance with the present embodiment as has been discussed above, when a paper jam occurs, the control unit 250c determine whether or not the remaining sheet(s) in the conveying routes can automatically be discharged, and display on the manipulation display 270 the result of determination in association with the position of the remaining sheet(s).

By this configuration, the user can be notified whether or not the remaining sheet(s) can automatically be discharged in association with the position of the remaining sheet(s) through the message displayed on the manipulation display 270. The user can thereby be notified of the situation (position and viability of the automatic discharge) of the remaining sheet(s) and determine how to handle the remaining sheet(s) by own decision. It is therefore possible to provide a user-friendly image forming system.

Also, in accordance with the present embodiment, the control unit 250c displays, on the manipulation display 270, the remaining sheets to be manually removed, i.e., the jammed sheet and the remaining sheet(s) determined as the sheets to be automatically discharged.

The remaining sheet(s) determined as cannot be automatically discharged has to be manually removed. However, in accordance with the present embodiment, it is possible to notify the user of the jammed sheet and the remaining sheet(s) determined as cannot be automatically discharged. Because of this, when manually removing the jammed sheet, the user is prompted to remove remaining sheet(s) which cannot automatically be discharged. Also, since it is possible to detect the position of each remaining sheet to be manually removed, the remaining sheet can be surely removed distinctively from the other remaining sheets. It is thereby possible to lighten the work load on the user when recovering from the jamming trouble and provide a user-friendly image forming system.

Also, in the case of the present embodiment, when determining that the jammed sheet and the remaining sheet(s) determined as cannot be automatically discharged have been removed from the conveying routes, the control unit 250c displays, on the manipulation display 270, the remaining sheet(s) determined as a sheet(s) which can be automatically discharged, as those to be automatically discharged.

In accordance with this configuration, after removing the jammed sheet and the remaining sheet(s) which cannot be automatically discharged, the remaining sheet(s) which can be automatically discharged are displayed. It is therefore possible to notify these results of determining the viability of automatic discharge distinctively from each other. Also, since the position of the remaining sheet(s) to be automatically discharged can be detected in advance of performing the automatic discharge, it is possible to prompt the user to select the automatic discharge or the manual removal of the remaining sheet(s).

Furthermore, in accordance with the present embodiment, the control unit 250c determines whether or not a remaining sheet in the conveying routes can automatically be discharged on the basis of the type of an apparatus in which the remaining sheet is remaining, the position of the remaining sheet in the apparatus and/or the condition of the apparatus.

In accordance with this configuration, it is possible to identify the reason for which a conveyance unit cannot convey a remaining sheet and appropriately determine whether or not the automatic discharge is viable.

For example, when a sheet is jammed followed by stopping conveyance of another sheet which is located in a position extending over a plurality of the conveyance units having different responsive behaviors to the stopping operation, this another sheet may be buckled and folded due to the stopping operation. Also, if the remaining sheet is stopping in a location where the conveying route curves with a curvature no lower than a threshold value, the remaining sheet may be irreversibly curved. Furthermore, if a sheet is jammed in an apparatus in which another sheet remains, a user may have touched or moved the remaining sheet in the apparatus when handling the jam trouble. Likewise, if the housing door of the apparatus is opened/closed after jamming, a user may have touched or moved the remaining sheet in the apparatus. Furthermore, since different apparatuses have different conveyance units, a remaining sheet which is located in a position extending over a plurality of the apparatuses may be buckled and folded due to the differential behavior between the adjacent apparatuses during stopping the remaining sheet. Also, a remaining sheet may be stopped during being conveyed the image forming apparatus in a location where a conveying route curves with a large curvature, or a location where the remaining sheet is extending over a plurality of the conveyance units having different responsive behaviors to the stopping operation.

In accordance with the present embodiment, it can be determined what hinders a remaining sheet from being automatically discharged by taking into consideration the above situations. It is therefore possible to effectively determine whether or not a remaining sheet can be automatically discharged.

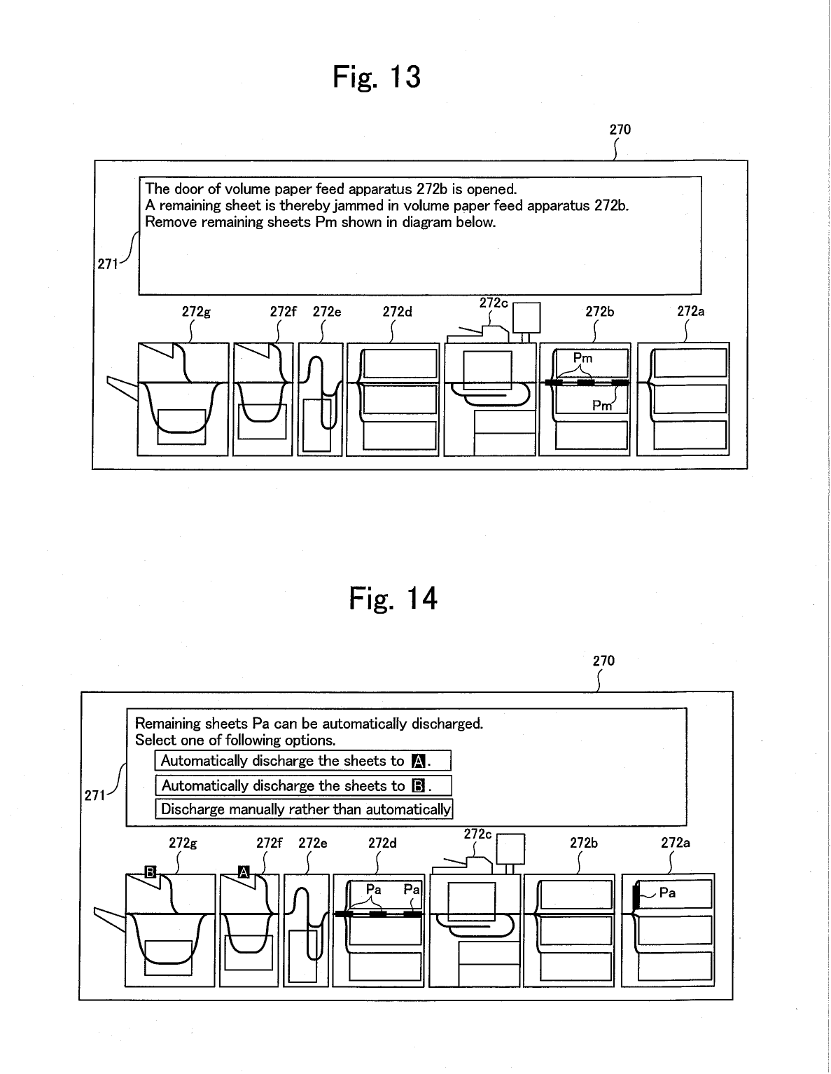

Incidentally, when the housing door of an apparatus is opened in advance of performing the automatic discharge, as illustrated in FIG. 13, the control unit 250c can display, on the manipulation display 270, the remaining sheet Pm located in this apparatus as a sheet to be manually removed.

A user may have touched or moved the remaining sheet in the apparatus whose housing door is opened after jamming. It is therefore possible to prompt the user to remove the remaining sheet hindering the automatic discharge by displaying the remaining sheet as a sheet to be manually removed.

Also, when it is determined that a remaining sheet is removed from an apparatus whose housing door is opened, the control unit 250c can display, on the manipulation display 270 as illustrated in FIG. 14, the remaining sheets Pa which can be automatically discharged as those to be automatically discharged.

In accordance with this configuration, the remaining sheets which can be automatically discharged is displayed after the remaining sheet is removed from an apparatus whose housing door is opened. By this configuration, the user is notified of the positions of the remaining sheets which can be automatically discharged, and can decide whether to perform the automatic discharge of the remaining sheets or manually remove the remaining sheets.

Also, when a remaining sheet is located in a position extending over the boundary between an apparatus whose housing door is opened and an adjacent apparatus, the remaining sheet can be moved to either apparatus with the timing of opening or closing the housing door as described in conjunction with step 25. Furthermore, in this case, the remaining sheet moved to either apparatus can be handled as a sheet which cannot automatically be discharged.

Incidentally, in the case of the present embodiment, when a remaining sheet stops in a position extending over a plurality of the apparatuses, the control unit 250c outputs a command to each apparatus to move the remaining sheet to either apparatus (step 25). However, this process may cause the moving remaining sheet to interfere with the preceding remaining sheet or the subsequent remaining sheet such that the two sheets may overlap each other, get folded or bended and so forth. Therefore, even if a remaining sheet stops in a position extending over a plurality of the apparatuses, it can be determined that this remaining sheet can be automatically discharged.

The foregoing description has been presented on the basis of the image forming system according to the present invention. However, it is not intended to limit the present invention to the precise form described, and obviously many modifications and variations are possible within the scope of the invention. For example, the present invention can be applied to an image forming system including one or more apparatus such as an image forming apparatus, a large volume paper feed apparatus, a finisher and so forth. Also, the present invention can be applied to an image forming system including a plurality of apparatuses which does not necessarily have independent hausings respectively, but can be contained within one housing in which the functions of these apparatuses are implemented.

What is claimed is:

1. An image forming system which performs a predetermined process of a sheet conveyed along a conveying route, comprising:
a conveyance unit configured to convey the sheet;
a display unit configured to display information;
a jam determination unit configured to determine if a paper jam occurs on the conveying route;
a paper management unit configured to manage the position of the sheet along the conveying route; and
a control unit configured to control said conveyance unit and said display unit on the basis of the result of determination by said jam determination unit and the position of the sheet managed by said paper management unit, wherein
when a paper jam occurs, said control unit determines whether or not a sheet remaining on the conveying route can be automatically discharged by driving said conveyance unit, and displays the result of determination on said display unit in association with the position of the sheet.

2. The image forming system of claim 1 wherein
said image forming system comprises a plurality of apparatuses connected in series, and wherein
said control unit determines whether or not a sheet can automatically be discharged on the basis of the type of an apparatus in which the sheet is remaining, the position of the sheet in the apparatus and/or the condition of the apparatus in which the sheet is remaining.

3. The image forming system of claim 2 wherein
when it is determined that a sheet is located in a position extending over a plurality of the conveyance units having different responsive behaviors to the operation of stopping conveyance of the sheet, said control unit determines that the sheet cannot automatically be discharged.

4. The image forming system of claim 2 wherein
when a sheet is remaining in a location where the conveying route curves with a curvature no lower than a threshold value, said control unit determines that the sheet cannot automatically be discharged.

5. The image forming system of claim 2 wherein
when it is determined that a sheet is remaining in an image forming apparatus, said control unit determines that the sheet cannot automatically be discharged.

6. The image forming system of claim 2 wherein
when a sheet is jammed in an apparatus in which another sheet remains in the conveying route, said control unit determines that the sheet cannot automatically be discharged.

7. The image forming system of claim 2 wherein
when it is determined that a sheet is remaining in the apparatus with a housing door being opened, said control unit determines that the sheet cannot automatically be discharged.

8. The image forming system of claim 1 wherein
said image forming system comprises a plurality of apparatuses connected in series, and wherein
when it is determined that a sheet is located in a position extending over a plurality of the apparatuses, said control unit determines that the sheet cannot automatically be discharged.

9. The image forming system of claim 1 wherein
said control unit displays a jammed sheet and a sheet which is remaining on the conveying route on said display unit as a sheet to be manually removed.

10. The image forming system of claim 9 wherein
when it is determined that the jammed sheet and the sheet determined as a sheet which cannot be automatically discharged have been removed from the conveying routes, said control unit displays a sheet determined as a sheet which can be automatically discharged on said display unit as a sheet to be automatically discharged.

11. The image forming system of claim 10 wherein
when the housing door of an apparatus is opened in advance of automatically discharging the sheets, said control unit displays a sheet remaining in the apparatus with the opened housing door on said display unit as a sheet to be manually removed.
